(19) United States
(12) Patent Application Publication
(10) Pub. No.: US 2026/0314871 A1
(43) Pub. Date: Oct. 15, 2026

(54) VENDING MACHINE FOR HEATING FOOD AND ITS OPERATING METHOD

(71) Applicant: YO-KAI EXPRESS INC., Hayward, CA (US)

(72) Inventor: Chih Hung LIN, San Jose, CA (US)

(73) Assignee: YO-KAI EXPRESS INC., Hayward, CA (US)

(21) Appl. No.: 19/485,029

(22) PCT Filed: May 16, 2024
(86) PCT No.: PCT/US2024/029679

§ 371 Date: Nov. 17, 2025

Related U.S. Application Data
(60) Provisional application No. 63/466,786, filed on May 16, 2023.

(51) Int. Cl. A47J 36/24; A23L 5/10; A47J 27/04; A47J 31/40; A47J 44/00; G07F 17/00

(52) U.S. Cl. CPC A47J 36/24; A23L 5/13; A47J 27/04; A47J 31/407; A47J 44/00; G07F 17/0078; A47J 2027/043

(57) ABSTRACT

Disclosed are a vending machine and its operation method. The vending machine comprises a main moving device and a first food supply device, the first food supply device including a first food storage module, a first food moving module and a steam heating module, the first food moving module being movably disposed between the first food storage module and the steam heating module, the steam heating module including a piercing pipe, the first food storage module being used to store and supply a first food package containing food to the first food moving module, the first food moving module being used to move to the steam heating module and allows the piercing pipe to pierce the first food package, the piercing pipe being used to output a steam into the first food package to heat the food, the first food moving module being further used to pour the heated food in the first food package to the container.

### BACKGROUND

### Technical Field

The present disclosure relates to a vending machine, and particularly to a vending machine capable of heating food.

### Related Art

Existing vending machines are relatively limited in the hot food they can sell because the heating functions of the vending machines only include heat preservation or hot water brewing. If it is a heat preservation method, the hot food sold is first prepared in the central kitchen, and then the hot foods are directly transported to the vending machine locations in various places, loaded into the vending machines, and heated by the vending machines. The device keeps foods warm. In this method, because the foods have already been prepared, even though the heating device keeps the foods hot, they lack fresh texture and taste. The hot water brewing method is limited to instant noodles or powder-based tea.

### SUMMARY

The present disclosure embodiment disposes a vending machine for heating food foods and an operating method thereof, which solves the problem in the prior art that hot food can only be supplied through heat preservation or hot water brewing, resulting in poor taste or limited variety.

In order to solve the above technical problems, the present disclosure provides a vending machine for heating food, which comprises a main moving device and a first food supply device. The main moving device is used for receiving and moving a container, and the first food supply device is disposed corresponding to the main moving device. the first food supply device includes a first food storage module, a first food moving module and a steam heating module, wherein the first food moving module is movably disposed between the first food storage module and the steam heating module, the steam heating module includes a piercing pipe, the first food storage module is used to store and supply a first food package containing food to the first food moving module, the first food moving module is used to move to the steam heating module and allows the piercing pipe to pierce the first food package, the piercing pipe is used to output a steam into the first food package to heat the food, the first food moving module is further used to pour the heated food in the first food package to the container.

In some embodiments, the first food package is a capsule with a cover film, and the piercing pipe is used to pierce the cover film of the first food package.

In some embodiments, the first food supply device further includes a first cover-removing module, and the first cover-removing module is disposed on a side of the steam heating module and is configured corresponding to the first food moving module, the first food moving module is used to move the heated first food package to the first cover-removing module, the first cover-removing module is used to remove the cover film of the first food package.

In some embodiments, the first cover-removing module includes an annular sawtooth portion.

In some embodiments, the first food supply device further includes an ice-making module for making ice cubes, and the ice-making module is configured corresponding to the first food moving module, the first food moving module is also used to move to the first food package below the ice making module after the piercing pipe outputs steam to heat the first food package and the first cover-removing module removes the cover film of the first food package, the ice making module is allowed to put ice cubes into the first food package.

In some embodiments, the first food supply device further includes a first food package recycling track, and the first food package recycling track corresponds to the first food moving module and is configured that after pouring the heated first food package into the container, the first food moving module is also used to move to the first food package recycling track to pour the first food package into the first food package recycling track.

In some embodiments, the first food storage module includes a plurality of first food package storage barrels arranged in an annular manner, and each first food package storage barrel is used for storing a plurality of the first food packages.

In some embodiments, the vending machine further includes a second food supply device, the second food supply device disposed corresponding to the main moving device and located on one side of the first food supply device; wherein the second food supply device includes a second food storage module, a second food moving module and a water supply and mixing module, the second food moving module is movably disposed on the second food storage module between the water supply and mixing module, the water supply and mixing module includes a mixing rod, a mixing container and an output pipe, the mixing rod is located above the mixing container, the output pipe is connected to the bottom of the mixing container, the second food storage module is used to store and supply a second food package containing food to the second food moving module, the second food moving module is used to move and pour the food in the second food package to the mixing container, the water supply and mixing module is used to supply water to the mixing container, the mixing rod is configured to enter the mixing container for mixing, and the water supply and mixing module enables the mixing container to output through the output pipe stir the foods and water into the container.

In some embodiments, the second food package is a capsule with a cover film, and the second food supply device further includes a second cover-removing module, and the second cover-removing module is disposed on one side of the water supply and mixing module. Corresponding to the setting of the second food moving module, the second food moving module is used to move the second food package to the second cover-removing module, and the second cover-removing module is used to remove the cover film of the second food package. The second food moving module is used to move the second food package with the film removed to the water supply and mixing module.

In some embodiments, the vending machine further includes a container storage barrel, a capping device and a pick-and-place device. The main moving device includes an annular rotating part for carrying the container. The first food supply device and the second food supply device, the container storage barrel and the pick-and-place device are arranged in an annular shape corresponding to the annular rotating part. The capping device is arranged on one side of the pick-and-place device. The annular rotating part is used to carry the container dropped from the container storage barrel and drive the container through the third food supply device, a second food supply device and a pick-and-place device. The capping device is used to cap the container. The pick-and-place device is used to output the capped container to the outlet.

The present disclosure also disposes a method for operating a vending machine, which includes: storing and supplying a first food package containing food; piercing the first food package with a piercing pipe; generating steam and outputting it through the piercing pipe steaming the food into the first food package to heat the food; pouring the heated food in the first food package into the container; and moving the container to the outlet.

In some embodiments, the first food package is a capsule with a cover film; the method of piercing the first food package with a piercing pipe further includes: piercing the cover film of the first food package with a piercing pipe.

In some embodiments, before pouring the foods in the heated first food package into the container, the method further includes: removing the cover film of the heated first food package.

In some embodiments, the method further includes: placing ice cubes into the first food package after removing the cover film of the heated first food package.

In some embodiments, the method further includes: moving the first food package to the first food package recycling track, and pouring the first food package into the first food package recycling track after pouring the foods in the heated first food package into the container.

In some embodiments, the method further includes: storing and supplying a second food package containing foods; moving and pouring the foods in the second food package into the mixing container; and supplying water to the mixing container; moving the mixing rod into the mixing container for mixing; and outputting the mixed foods and water in the mixing container to the container through the output pipe.

In some embodiments, the second food package is a capsule with a cover film; the method further includes: removing the cover film of the second food package before moving and pouring the foods in the second food package into the mixing container.

In some embodiments, the method further includes: placing the container from the container storage barrel to the annular rotating part; the rotating part driving the container to the bottom of the mixing container after pouring out the foods in the heated first food package to the container; and the container is capped, and the capped container is output to the outlet after outputting the mixed foods and water in the mixing container to the container through the output pipe.

An embodiment of the present disclosure provides a vending machine for heating food and operating method thereof. Through the design and cooperation of the steam heating module and the puncture pipe, steam can be generated on the spot when the vending machine accepts the order. By piercing the puncture pipe of the food package, steam is output into the food package, and the food in the food package is directly heated. This solves the problem that hot food can only be supplied through heat preservation or hot water brewing, resulting in poor taste and a restricted variety.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments are believed to be novel, and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a front view of a vending machine according to one embodiment of the present disclosure.

FIG. 2 is an internal schematic diagram of a vending machine according to an embodiment of the present disclosure.

FIG. 3 is a schematic diagram of a main moving device and a container storage barrel according to an embodiment of the present disclosure.

FIG. 4 is a schematic diagram of a first food supply device and a second food supply device according to an embodiment of the present disclosure.

FIG. 5 is a top view of the first food supply device and the second food supply device according to an embodiment of the present disclosure.

FIG. 6 is a schematic diagram of a second food supply device according to an embodiment of the present disclosure.

FIG. 7 is a schematic diagram of a capping device and a pick-and-place device according to an embodiment of the present disclosure.

FIG. 8 is a partial schematic view of the first food supply device according to an embodiment of the present disclosure.

FIG. 9 is a partial schematic diagram 2 of the first food supply device according to an embodiment of the present disclosure.

FIG. 10 is a partial schematic diagram of a second food supply device according to an embodiment of the present disclosure.

FIG. 11 is a flowchart 1 of a method of operating a vending machine according to an embodiment of the present disclosure.

FIG. 12 is a flowchart 2 of a method of operating a vending machine according to an embodiment of the present disclosure.

FIG. 13 is a flowchart 3 of a method of operating a vending machine according to an embodiment of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are disposed so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description disclosed some embodiments of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

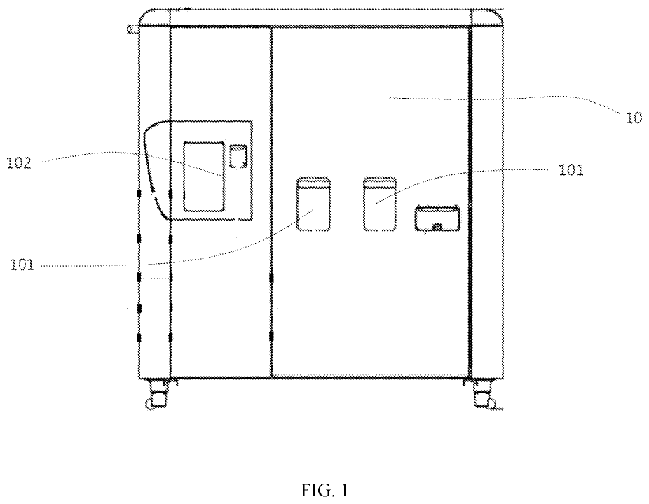

Please refer to FIG. 1, which is a front view of the appearance of the vending machine 10 according to one embodiment of the present disclosure. In this embodiment, the vending machine 10 can directly heat the foods on the spot after accepting the consumer's order. The appearance of the vending machine 10 includes an outlet 101 connected inside and used for supplying meals (food or drinks) and an ordering system 102. The ordering system 102 is used to accept operations from consumers to generate orders.

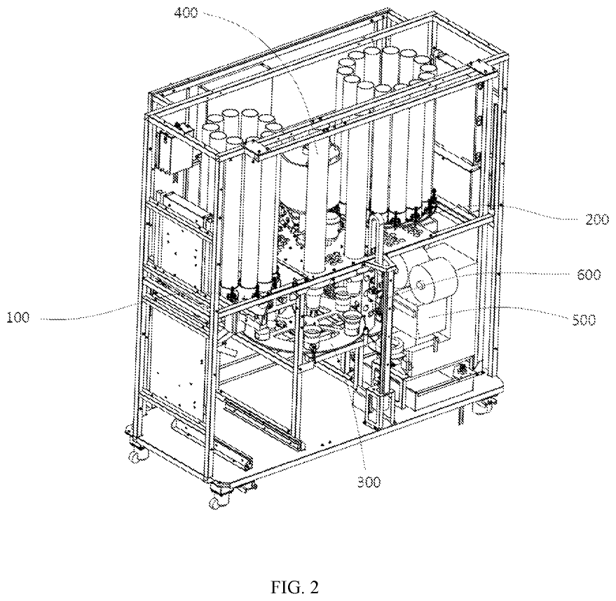

Please refer to FIG. 2, which is an internal schematic diagram of the vending machine 10 according to an embodiment of the present disclosure. In this embodiment, the vending machine 10 includes a main moving device 300 and a first food supply device 100. The main moving device 300 is used to receive and move the container C. The first food supply device 100 is disposed corresponding to the main moving device 300. The moving device 300 can move the container C to a relevant position of the first food supply device 100 so that the container C can receive the food supplied by the first food supply device 100. The first food supply device 100 can heat food through steam, which will be described in detail later.

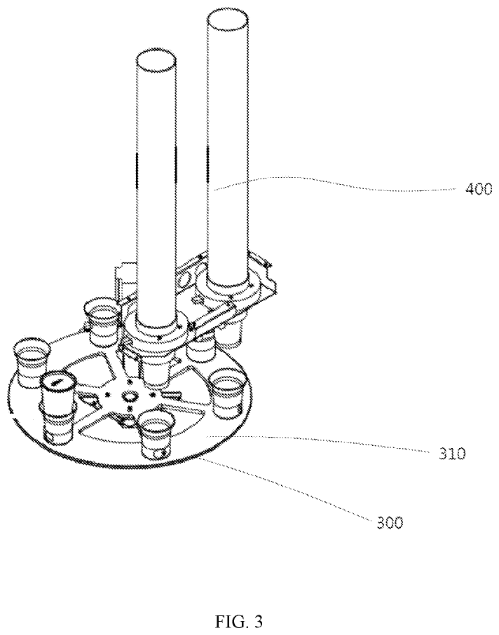

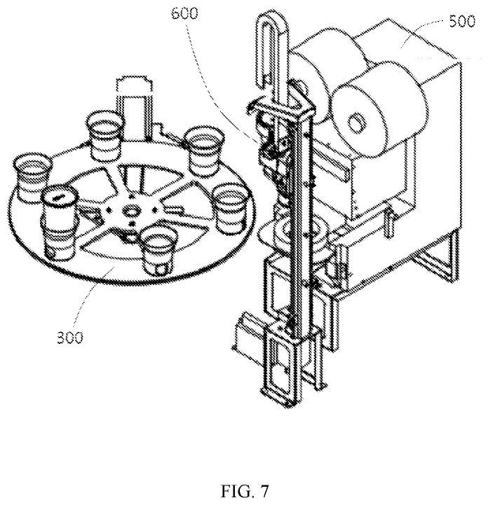

Please refer to FIGS. 2, 3 and 7. FIG. 3 is a schematic diagram of the main moving device 300 and the container storage barrel 400 according to one embodiment of the present disclosure. FIG. 7 is a capping device 500 according to one embodiment of the present disclosure. and a schematic diagram of the pick and place device 600. In some embodiments, the vending machine 10 further includes a second food supply device 200, a container storage barrel 400, a capping device 500, and a picking and placing device 600. The main moving device 300 includes an annular rotating part 310 for carrying the container C. The first food supply device 100, the second food supply device 200, the container storage barrel 400 and the pick-and-place device 600 correspond to the annular rotating part 310. Similarly, the capping device 500 is disposed on one side of the pick-and-place device 600. In some embodiments, there may be more than two container storage barrels 400, and each container storage barrel 400 stores a plurality of containers C stacked in a vertical direction. The containers C are, for example, but not limited to cups. In some embodiments, the annular rotating part 310 is used to carry the container C dropped from the container storage barrel 400, and the annular rotating part 310 can be rotated by a motor, and the dropped container C will be set on the annular rotating part 310. Arranged in an annular shape around the container, the annular rotating portion 310 can rotate to drive the container C through the first food supply device 100, the second food supply device 200 and the pick-and-place device 600. The container C can receive the corresponding foods, water or beverages when passing through the first food supply device 100 and the second food supply device 200, and the pick-and-place device 600 can take out the already filled foods, water or drinks on the annular rotating part 310. The capping device 500 can cap the container C on the pick-and-place device 600, and the pick-and-place device 600 will output the capped container C to the outlet 101 for consumers to take.

In some embodiments, the main moving device 300 includes a robotic arm for grabbing or carrying the container C. The robotic arm can replace the annular rotating part 310 or cooperate with the annular rotating part 310 to move the container C to the desired location. Location.

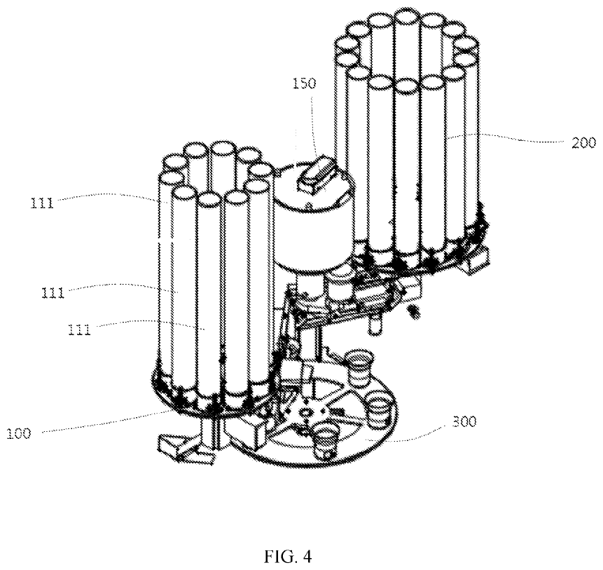

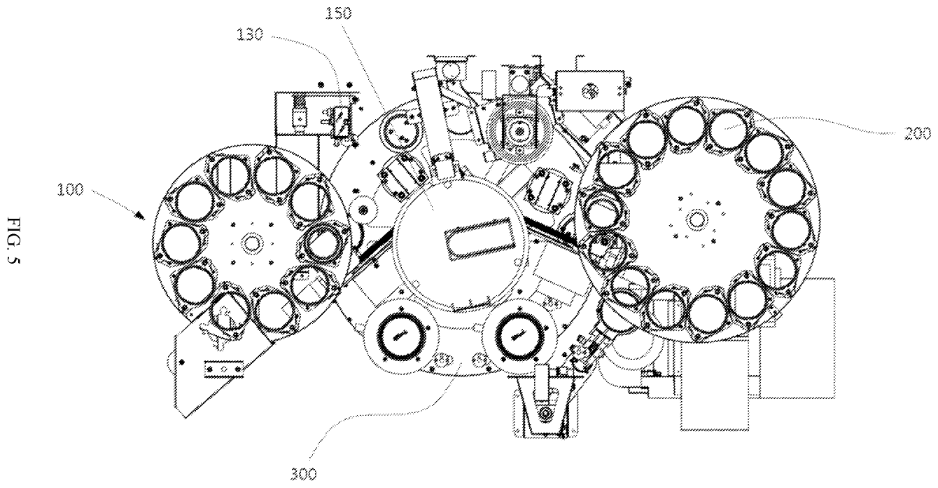

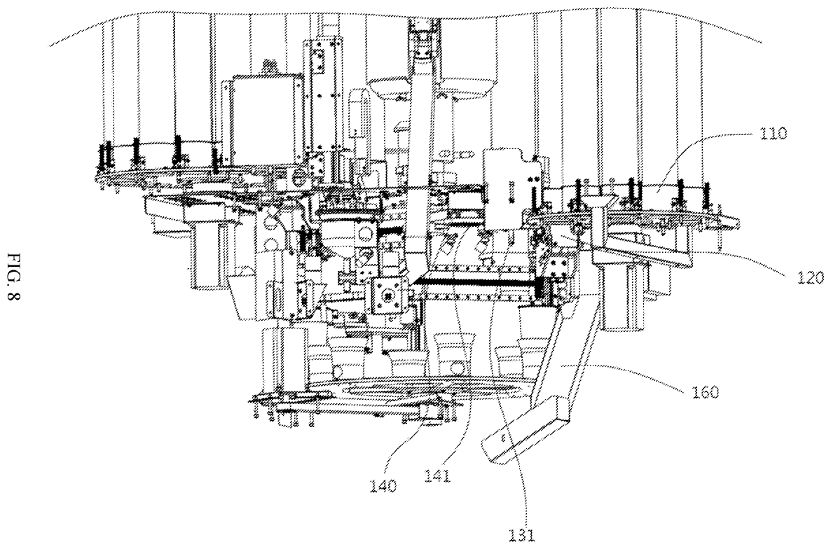

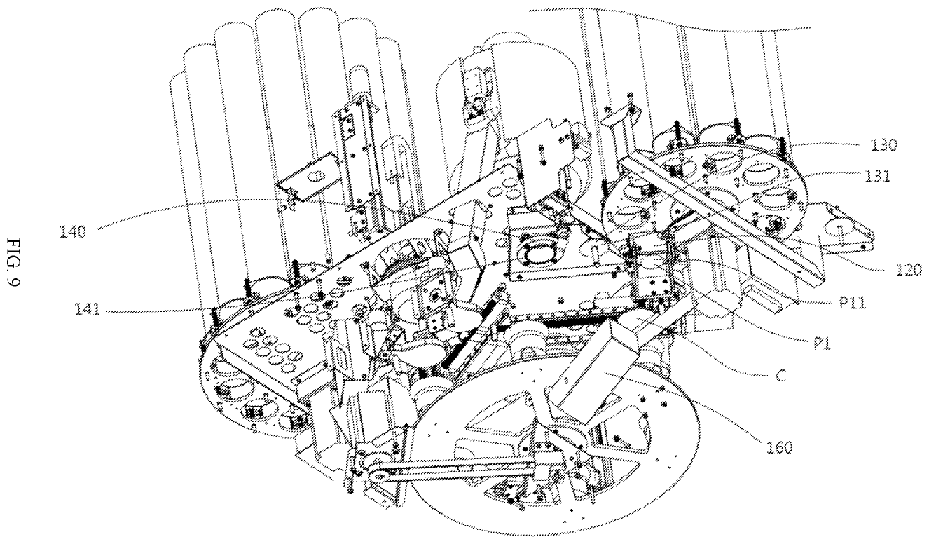

Please refer to FIGS. 4, 5, 8 and 9. FIG. 4 is a schematic diagram of the first food supply device 100 and the second food supply device 200 according to an embodiment of the present disclosure. FIG. 5 is a schematic diagram of the present disclosure. A top view of the first food supply device 100 and the second food supply device 200 of the embodiment. FIG. 8 is a partial schematic view of the first food supply device 100 of the embodiment. FIG. 9 is a partial schematic diagram of the first food supply device 100 of the embodiment. The present disclosure is a top view of the second food supply device 200. Partial schematic diagram 2 of the first food supply device 100. In this embodiment, the first food supply device 100 includes a first food storage module 110, a first food moving module 120 and a steam heating module 130. The first food moving module 120 is movably disposed on the first food. Between the storage module 110 and the steam heating module 130, the steam heating module 130 includes a puncture pipe 131. In some embodiments, the steam heating module 130 has a steam generating component, such as a boiler, which can generate steam with a certain pressure in the boiler in a short time; the puncture pipe 131 has a steam channel inside, and the puncture pipe 131 is close to There is an opening connected to the vapor channel at the tip, and the vapor can be output through the vapor channel and the opening. The first food storage module 110 can store a plurality of first food packages P1, and each first food package P1 stores food. The first food storage module 110 can also supply the first food package P1 to the first food moving module 120. For example, the first food moving module 120 has a slot for receiving the first food package P1. The first food storage module 110 can allow the first food package P1 to fall into the slot of the first food moving module 120, and the first food moves The module 120 can move to the steam heating module 130 together with the first food package P1, so that the first food package P1 is aligned with the moving path of the piercing tube 131, so that the piercing tube 131 can move and pierce the first food package P1. After the piercing pipe 131 pierces the first food package P1, the piercing pipe 131 can output steam into the first food package P1, and heat the food with steam under a certain pressure. After the heating is completed, the piercing pipe 131 will move out the first food package P1, and the first food moving module 120 will pour the heated food in the first food package P1 to the container C.

In some embodiments, the first food package P1 is a capsule with a cover film P11, and the puncture tube 131 can penetrate the cover film P11 of the first food package P1 and enter the first food package P1. In some embodiments, the foods in the first food package P1 are pearls in the beverage foods. When the steam is sent into the first food package P1, the high pressure and steam can cook the pearls in a short time.

As shown in FIGS. 8 and 9, in some embodiments, the first food supply device 100 also includes a first cover-removing module 140, and the first cover-removing module 140 is disposed on a side of the steam heating module 130. side and is disposed corresponding to the first food moving module 120. After the heating of the first food package P1 is completed and the piercing pipe 131 moves out of the first food package P1, the first food moving module 120 will move the heated first food package P1 to the first cover-removing module 140. The cover module 140 can completely remove the cover film P11 of the first food package P1. In some embodiments, the first cover-removing module 140 includes an annular sawtooth portion 141 that can contact the periphery of the cover film P11 of the first food package P1 and perform rotational cutting to remove the cover film P11.

As shown in FIGS. 4 and 5, in some embodiments, the first food supply device 100 also includes an ice making module 150 for making ice cubes. The ice making module 150 corresponds to the first food moving module. Group 120 settings. After the piercing pipe 131 outputs steam to heat the foods of the first food package P1, and the first food removing module 140 removes the cover film P11 of the first food package P1, the first food moving module 120 can further move the first food The package P1 moves below the ice-making module 150, allowing the ice-making module 150 to put ice cubes into the first food package P1 to chill the newly heated foods. When the food is pearls, heating and chilling can add a chewy texture.

In some embodiments, the first food supply device 100 also includes a first food package recycling track 160. The first food package recycling track 160 is configured corresponding to the first food moving module 120. The first food moving module 120 After pouring the foods in the heated first food package P1 to the container C, the first food moving module 120 can also take the empty first food package P1 and move it to the top of the first food package recycling track 160 and move it The first food package P1 is poured onto the first food package recycling track 160, and the first food package P1 can slide along the first food package recycling track 160 into the recycling barrel.

In some embodiments, after the piercing pipe 131 outputs steam to heat the foods of the first food package P1, and the first cover-removing module 140 removes the cover film P11 of the first food package P1, the first food moving module The group 120 may first pour the heated foods in the first food package P1 into the container C, and then the ice making module 150 may put ice cubes into the container C. In some embodiments, the ice making module 150 may also be configured corresponding to the main moving device 300, and after the first food moving module 120 pours the heated food in the first food package P1 to the container C, the main moving device 300 moves the container C to the ice making module 150, allowing the ice making module 150 to put ice cubes into the container C.

In some embodiments, the first food storage module 110 includes a plurality of first food package storage barrels 111 arranged in an annular manner, and each first food package storage barrel 111 can store a plurality of first food packages P1, The plurality of first food packages P1 of each first food package storage barrel 111 may be stacked in a vertical direction.

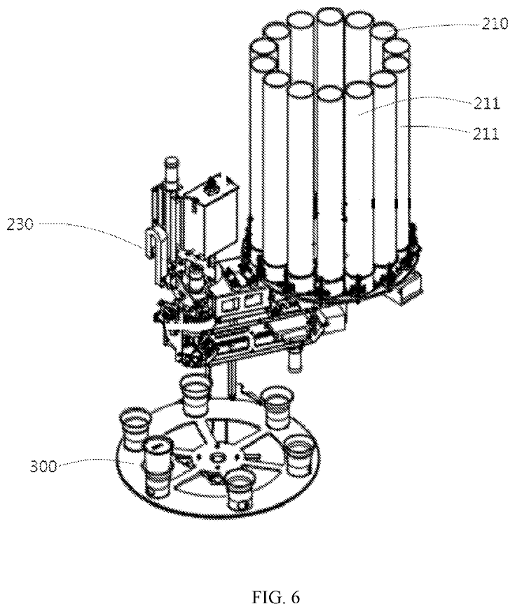

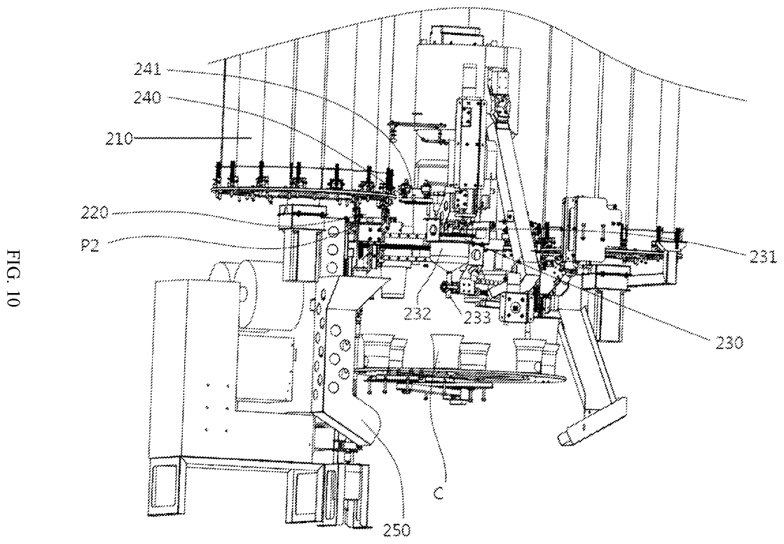

Please refer to FIGS. 4, 5, 6 and 10. FIG. 6 is a schematic diagram of a second food supply device 200 according to an embodiment of the present disclosure. FIG. 10 is a second food supply device according to an embodiment of the present disclosure. A partial schematic of the device 200. The second food supply device 200 is disposed corresponding to the main moving device 300 and is located on one side of the first food supply device 100. In this embodiment, the first food supply device 100 and the second food supply device 200 are respectively located on opposite sides of the main moving device 300. The second food supply device 200 includes a second food storage module 210, a second food moving module 220, and a water supply and mixing module 230. The second food moving module 220 is movably disposed between the second food storage module 210 and the second food moving module 220. Between water supply and mixing module 230. The water supply and mixing module 230 includes a mixing rod 231, a mixing container 232 and an output pipe 233. The mixing rod 231 is located above the mixing container 232, and the output pipe 233 is connected to the bottom of the mixing container 232. The second food storage module 210 can store a plurality of second food packages P2 containing food, and can supply the second food packages P2 to the second food moving module 220. The principle can be referred to the aforementioned first food storage module 110. The method and configuration of the first food package P1. The second food moving module 220 can move the second food package P2 to the side of the mixing container 232 and pour the food in the second food package P2 into the mixing container 232. The water supply and mixing module 230 can supply water to the mixing container 232, and the mixing rod 231 can move downward to enter the mixing container 232 to stir the food and water in the mixing container 232. After the mixing is completed, the water supply and mixing module 230 can also enable the mixing container 232 to output the mixed foods and water to the container C through the output pipe 233. For example, there is a valve between the mixing container 232 and the output pipe 233 at the bottom. Before and during mixing, the valve is closed; when the mixing is completed, the valve will open, allowing the food and water to flow to the container C through the valve and the output pipe 233.

In some embodiments, the second food package P2 is a capsule with a cover film, and the second food supply device 200 also includes a second cover-removing module 240, and the second cover-removing module 240 is disposed in the water supply and mixing system. One side of the module 230 is disposed corresponding to the second food moving module 220. Before moving the second food package P2 to the water supply and mixing module 230, the second food moving module 220 will first move the second food package P2 to the second cover-removing module 240. The second cover-removing module 240 can first Remove the cover film of the second food package P2, and the second food moving module 220 moves the second food package P2 with the film removed to the water supply and mixing module 230, and pours the food in the second food package P2 into the mixing container. 232. In some embodiments, the second cover-removing module 240 includes an annular sawtooth portion 241 that can rotate to cut and remove the cover film of the second food package P2.

In some embodiments, before or after the water supply and mixing module 230 outputs the mixed foods and water to the container C, the main moving device 300 moves the container C to the ice making module 150, so that the ice making module 150 Place ice cubes into container C. In some embodiments, after the first food moving module 120 pours the heated food in the first food package P1 to the container C, the main moving device 300 moves the container C to the ice making module 150 so that the ice making mold The group 150 puts ice cubes into the container C, and then moves the container C to the water supply and mixing module 230, so that the water supply and mixing module 230 outputs the mixed foods and water to the container C. In some embodiments, the first food moving module 120 pours the heated food in the first food package P1 to the container C, and the water supply and mixing module 230 also outputs the mixed food and water to the container C. Afterwards, the main moving device 300 moves the container C to the ice making module 150, allowing the ice making module 150 to put ice cubes into the container C.

In some embodiments, the second food storage module 210 includes a plurality of second food package storage barrels 211, and each second food package storage barrel 211 stores a plurality of second food packages P2. The second food supply device 200 further includes a second food package recycling track 250, and the second food moving module 220 can pour the empty second food package P2 onto the second food package recycling track 250.

In some embodiments, the foods in the second food package P2 are, for example but not limited to, tea powder or sugar powder. The water supply and mixing module 230 can supply water to the water in the mixing container 232, such as but not limited to hot water.

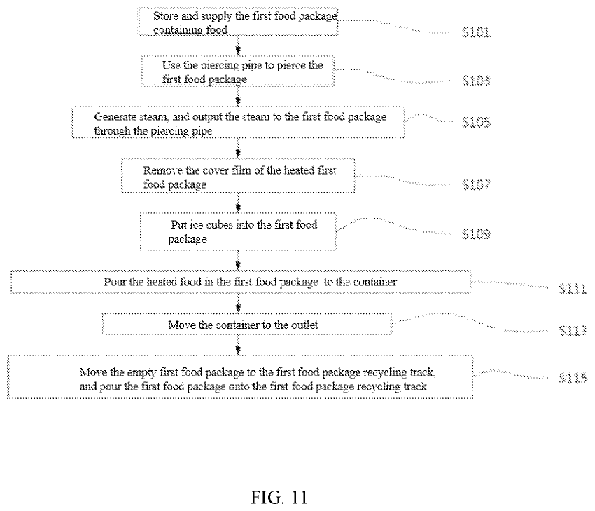

Please refer to FIG. 11, which is a flowchart 1 of the operation method of the automatic vending machine 10 according to the present disclosure. It is mainly an operation method of the first food supply device 100. In step S101, the first food storage module 110 stores and supplies the first food package P1 containing food; in step S103, the steam heating module 130 uses the piercing pipe 131 to pierce the first food package P1; step S105: the steam heating module 130 generates a steam, and outputs the steam to the first food package P1 through the piercing pipe 131; step S107: the first cover-removing module 140 removes the cover film P11 of the heated first food package P1; in step S109, the ice making module 150 puts ice cubes into the first food package P1; in step S111, the first food moving module 120 pours the food in the heated first food package P1 to the container C; S113: The main moving device 300 moves the container C to the pick-and-place device 600, the pick-and-place device 600 takes out the container C and moves it to the outlet 101 for supply to a consumer; Step S115: the first food moving module 120 moves the empty first food package P1 to the first food package recycling track 160, and pours the first food package P1 onto the first food package recycling track 160. In some embodiments, after the above step S107, step S111 would be performed directly, and after the first food moving module 120 pours the heated food in the first food package P1 to the container C, the ice making module 150 then puts ice cubes into container C.

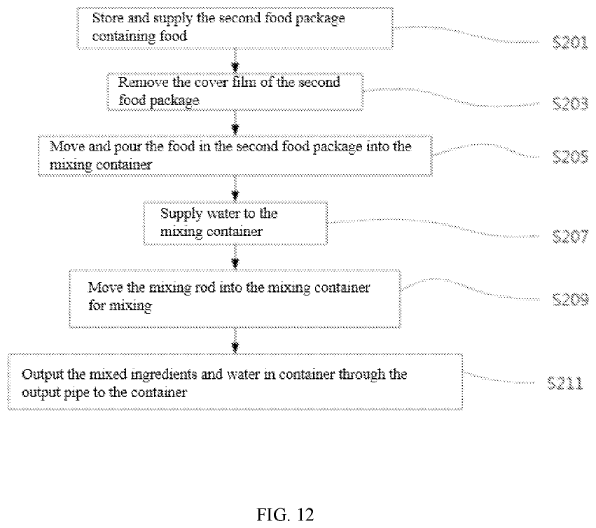

Please refer to FIG. 12, which is a flow chart 2 of the operation method of the automatic vending machine 10 according to the present disclosure. It is mainly an operation method of the second food supply device 200, in which step S201: the second food storage module 210 stores and supplies the second food package P2 containing food; step S203: the second cover-removing module 240 removes the cover film of the second food package P2; in step S205, the second food moving module 220 moves and pours the food in the second food package P2 into the mixing container 232; in step S207, the water supply and mixing module 230 supplies water to the mixing container 232; in step S209, the water supply and mixing module 230 moves the mixing rod 231 into the mixing container 232 for mixing; in step S211, the water supply and mixing module 230 outputs the mixed food and water in the mixing container 232 through the output pipe 233 into the container C. In some embodiments, before or after the above step S211, the main moving device 300 moves the container C to the ice making module 150, allowing the ice making module 150 to put ice cubes into the container C.

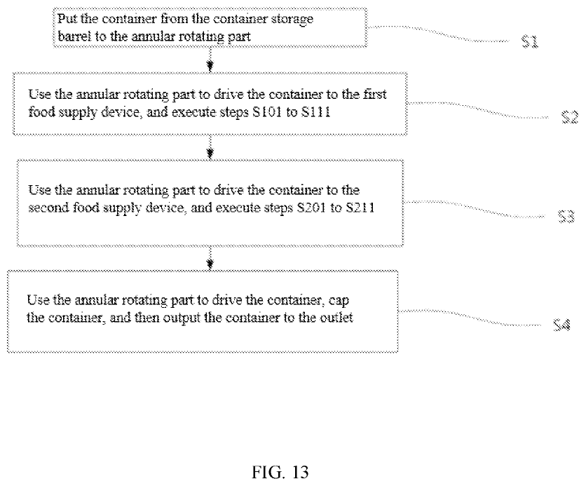

Please refer to FIG. 13, which is a flow chart 3 of the operation method of the vending machine 10 according to the present disclosure. It is mainly an overall operation method of the vending machine 10, in which step S1 is to put the container C from the container storage barrel 400 to the annular rotating part 310; step S 2 is to use the annular rotating part 310 to drive the container C to the first food supply device 100, and perform steps S101 to S111; step S3 is to use the annular rotating part 310 to drive the container C to the second food supply device 200, and perform steps S201 to S211; step S4 is to use the annular rotating part 310 to drive the container C to the location of the pick-and-place device 600, the pick-and-place device 600 takes out the container C, the capping device 500 caps the container C, and then the pick-and-place device 600 outputs the container C to the outlet 101 for consumption by consumers.

To sum up, the embodiment of the present disclosure disposes a vending machine that can heat food foods and its operation method. Through the design and cooperation of the steam heating module and the puncture pipe fittings, the vending machine can accept orders on the spot., can generate steam, and output the steam into the food package through the pierced pipe fitting of the food package, directly heating the food in the food package, solving the problem that hot food can only be supplied through heat preservation or hot water brewing, resulting in poor taste., bad taste or limited variety. Moreover, through the cooperation of the first food supply device and the second food supply device, the vending machine of the present disclosure can automatically produce freshly brewed drinks with freshly brewed pearls inside, so that consumers do not need to go to the store to purchase. The present disclosure's vending machine allows you to taste pearl drinks that are as good as freshly made in the store.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A vending machine for heating food, comprising:
a main moving device for receiving and moving a container; and
a first food supply device disposed corresponding to the main moving device, the first food supply device including a first food storage module, a first food moving module and a steam heating module, the first food moving module being movably disposed between the first food storage module and the steam heating module, the steam heating module including a piercing pipe, the first food storage module being used to store and supply a first food package containing food to the first food moving module, the first food moving module being used to move to the steam heating module and allows the piercing pipe to pierce the first food package, the piercing pipe being used to output a steam into the first food package to heat the food, the first food moving module being further used to pour the heated food in the first food package to the container.

2. The vending machine according to claim 1, wherein the first food package is a capsule with a cover film, and the piercing pipe is used to pierce the cover film of the first food package.

3. The vending machine according to claim 2, wherein the first food supply device further includes a first cover-removing module, and the first cover-removing module is disposed on a side of the steam heating module and is disposed corresponding to the first food moving module, the first food moving module is used to move the heated first food package to the first cover-removing module, the first cover-removing module is used to remove the cover film of the first food package.

4. The vending machine according to claim 3, wherein the first cover-removing module includes an annular sawtooth portion.

5. The vending machine according to claim 3, wherein the first food supply device further includes an ice-making module for making ice cubes, and the ice-making module is configured corresponding to the first food moving module, the first food moving module is also used to move to the first food package below the ice making module after the piercing pipe outputs steam to heat the first food package and the first cover-removing module removes the cover film of the first food package, the ice making module is allowed to put ice cubes into the first food package.

6. The vending machine according to claim 3, wherein the first food supply device further includes an ice-making module for making ice cubes, and the ice-making module corresponds to the first food moving module or the main moving device, and the ice making module is used to put ice cubes into the container after the first food moving module pours out the heated food in the first food package to the container.

7. The vending machine according to claim 1, wherein the first food supply device further includes a first food package recycling track, and the first food package recycling track corresponds to the first food moving module and is configured that after pouring the heated first food package into the container, the first food moving module is also used to move to the first food package recycling track to pour the first food package into the first food package recycling track.

8. The vending machine according to claim 1, wherein the first food storage module includes a plurality of first food package storage barrels arranged in an annular manner, and each first food package storage barrel is used to store a plurality of the first food packages.

9. The vending machine according to claim 1, further comprising a second food supply device, the second food supply device being disposed corresponding to the main moving device and disposed on one side of the first food supply device; wherein the second food supply device includes a second food storage module, a second food moving module and a water supply and mixing module, the second food moving module being movably disposed between the second food storage module and the water supply and mixing module, the water supply and mixing module including a mixing rod, a mixing container and an output pipe, the mixing rod being disposed above the mixing container, the output pipe being connected to the bottom of the mixing container, the second food storage module being used to store and supply a second food package containing food to the second food moving module, the second food moving module being used to move and pour the food in the second food package to the mixing container, the water supply and mixing module being used to supply water to the mixing container, the mixing rod being configured to enter the mixing container for mixing, and the water supply and mixing module allowing the mixing container to output through the output pipe the mixed food and water into the container.

10. The vending machine according to claim 9, wherein the second food package is a capsule with a cover film, and the second food supply device further includes a second cover-removing module, and the second food supply device further includes a second cover-removing module being disposed on one side of the water supply and mixing module and disposed corresponding to the second food moving module, the second food moving module being used to move the second food package to the second cover-removing module, the second cover-removing module being used to remove the cover film of the second food package, and the second food moving module being used to move the second food package with the cover film removed to the water supply and mixing module.

11. The vending machine according to claim 9, further comprising a container storage barrel, a capping device and a pick-and-place device, the main moving device including an annular rotating part for carrying the container, the first food supply device, the second food supply device, the container storage barrel and the pick-and-place device being arranged in an annular shape corresponding to the annular rotating part, the capping device being disposed on one side of the pick-and-place device, the annular rotating part being used to carry the container dropped from the container storage barrel and drive the container through the first food supply device, the second food supply device and the pick-and-place device, the capping device being used to seal the container, and the pick-and-place device being used to output the capped container to an outlet.

12. A method of operating a vending machine, including:
storing and supplying a first food package containing food;
piercing the first food package with a piercing pipe;
outputting a steam and output the steam through the piercing pipe into the first food package to heat the food;
pouring the heated food in the first food package into a container; and
moving the container to an outlet.

13. The method according to claim 12, wherein the first food package is a capsule with a cover film; the method of piercing the first food package with the piercing pipe further includes: using the piercing pipe to pierce the cover film of the first food package.

14. The method according to claim 13, wherein before pouring the heated first food package into the container, the operation method further comprises: removing the cover film of the first food package.

15. The method according to claim 14, wherein after removing the cover film of the heated first food package, the operation method further comprises: putting ice cubes into the first food package.

16. The method according to claim 14, wherein after pouring the heated foods in the first food package into the container, the operation method further comprises: putting ice cubes into the container.

17. The method according to claim 12, wherein after pouring the heated foods in the first food package into the container, the operation method further comprises: moving the first food package to a first food package recycling track to pour the first food package onto the first food package recycling track.

18. The method according to claim 12, further comprising:
storing and supplying a second food package containing foods;
moving and pouring food in the second food package into a mixing container;
pouring water into the mixing container;
moving a mixing rod into the mixing container to mix; and
outputting mixed food and water in the mixing container to the container through an output pipe.

19. The method according to claim 18, wherein the second food package is a capsule with a cover film; before moving and pouring the food in the second food package into the mixing container, the operation method further comprises: removing the covering film of the second food package.

20. The method according to claim 18, further comprising:
dropping the container from a container storage barrel to an annular rotating part;
using the annular rotating part to drive the container below the mixing container after pouring the heated foods in the first food package into the container; and
capping the container and outputting the capped container to an outlet after outputting the mixed foods and water in the mixing container to the container through the output pipe.
